(19) United States
(12) Patent Application Publication
(10) Pub. No.: US 2023/0419342 A1
(43) Pub. Date: Dec. 28, 2023

(54) PROCESSING APPARATUS AND METHOD FOR DETERMINING A MEASURE OF SUPPLY-DEMAND BALANCE FOR TRANSPORT-RELATED SERVICES

(71) Applicant: GRABTAXI HOLDINGS PTE. LTD., Singapore (SG)

(72) Inventors: Chun Kai PHANG, Singapore (SG); Huicong GUO, Singapore (SG); Prashant KUMAR, Singapore (SG); Qi Joseph ZHOU, Singapore (SG)

(21) Appl. No.: 18/029,292

(22) PCT Filed: Oct. 26, 2021
(86) PCT No.: PCT/SG2021/050651

§ 371 Date: Mar. 29, 2023

(30) Foreign Application Priority Data
Nov. 2, 2020 (SG) 10202010876R

(51) Int. Cl. G06Q 30/0202; G06Q 30/0204

(52) U.S. Cl. CPC G06Q 30/0202; G06Q 30/0205

(57) ABSTRACT

A processing apparatus is provided, to generate, based on a demand by service users and a supply of service providers for transport-related services at a defined geographical area over a defined time period, respective demand data indicative of service users with bookings and service users with the bookings and allocated with service providers, respective supply data indicative of service providers that are available during the defined time period for the services and service providers that become unavailable by the end of the defined time period, first metric data based on the respective demand data, second metric data based on the respective supply data, and score data indicative of a score indicator for determining the measure of supply-demand balance for the defined geographical area, the score indicator being computed based on the first metric data and the second metric data.

### TECHNICAL FIELD

The invention relates generally to the field of communications. One aspect of the invention relates to a processing apparatus for determining a measure of supply-demand balance for transport-related services. Another aspect of the invention relates to a method for determining a measure of supply-demand balance for transport-related services.

One aspect of the invention has particular, but not exclusive, application for determining the supply and demand for transport-related services, for example, the supply-demand balance and related surge performance (e.g., price surging).

### BACKGROUND

For some aspects of transport-related services, surge pricing is a useful mechanism for supply constrained markets when there is more demand than the supply available. The goal of the surge engine is to manage demand at a given level of supply, so as to clear the market. Evaluating the performance of the surge engine requires looking at both the demand and supply side of the market. How do we quantify the optimality of the surge engine?

It is challenging for the surge engine to clear the market effectively without having an objective measure for its performance. Known methods of measuring surge engine's performance were to rely on multiple allocation rate indicators such as effective first-time allocation rate (EFTA), first-time allocation rate (FTA), effective allocation rate, allocation rate, and unique passenger allocation rate. However, allocation rate only measures a single side of the market, and drivers may end up not having a job if surge only responds to allocation rate. Some known surge engines respond to the utilisation rate of drivers, which refers to the proportion of drivers' available time where they are on a job. Furthermore, allocation rate and utilisation rate changes could happen due to changes in inherent demand and supply, and may not completely reflect the performance of the surge engine.

It is challenging for the surge engine to know how much or how little it should surge. The higher surge is, the less likely it is for passengers to attempt to book a ride, for example. The ideal level of surge is where surge is just high enough to sufficiently dampen demand such that just enough passengers are booking a ride to be able to utilise idle drivers. The surge engine is over-surging if surge is too high, in which case too many passengers bounce after making a fare check due to the expensiveness, and drivers are left idling around because there is no demand. On the contrary, the surge engine is under-surging if surge is too low and too many passengers convert from making a fare check to booking. In such cases, allocation rate is poor due to fares not reaching drivers' reservation wages or simply due to passengers outnumbering available drivers.

The problem with known indicators led to the phenomenon of there being no objective means of measuring surge engine performance. And without this knowledge, the surge engine could end up over-surging or under-surging. In addition, there is no clarity on the amount of trade-off that is permissible if one metric improves while the other worsens when AB-testing different surge models.

### SUMMARY

Aspects of the invention are as set out in the independent claims. Some optional features are defined in the dependent claims.

Implementation of the techniques disclosed herein may provide significant technical advantages. Optimising or determining the supply-demand balance for transport-related services, which may lead to a balance between over-surging and under-surging, can potentially affect the processing load of the system or processing apparatus. An over-supply, where there are more or excessive service providers available compared to service users for the transport-related services, may lead to under-surging. When this happens, the service providers may not wish to accept the jobs and the system has to continually allocate the jobs to different service providers. At the same time, the service users may become frustrated with the longer wait for service providers to accept the jobs, which, in turn, may cause the service users to cancel the bookings already made and then try to re-book. All these may add to the system processing burden and network traffic, which may potentially result in a slower processing power and/or processing time. On the other hand, an under-supply, where there are insufficient service providers available compared to service users for the transport-related services, may lead to over-surging. When this happens, some service users may choose not to proceed with bookings for the transport-related services, resulting in less jobs being allocated to the service providers. This may lead to less network traffic and under-utilisation of the processing power of the system. As such, by determining the supply-demand balance, the techniques disclosed herein may lead to optimisation of the processing power and/or processing time of the system or processing apparatus. Optimisation of the processing power may lead to the system processing threads being executed more efficiently and quickly such that there may be fewer processing threads left open or active in parallel, thereby reducing the overall processing burden on the system at any one time.

In at least some implementations, the techniques disclosed herein may enable determination of one or more parameters related to supply-demand balance and related surge performance for transport-related services, which may help to minimise the risk of over-supply or under-supply of service providers for the transport-related services. Ensuring supply-demand balance may also enable balance between over-surging and under-surging.

In at least some implementations, the techniques disclosed herein may provide for a score indicator to be computed based on supply and demand, where the score indicator may provide a measure of supply-demand balance for a defined geographical area (e.g., an area within a city). Weights may be applied to parameters related to the supply side and the demand side respectively to cater to the degree the parameters are to be accounted for in the score indicator.

In at least some implementations, due to the different levels of demand and supply across space and/or time, the techniques disclosed herein allow for modifying the score indicator by a weight or factor to compute a weighted score indicator.

In at least some implementations, the techniques disclosed herein allow for determination of a measure of supply-demand balance for a larger geographical region, for example, a city, to monitor overall city performance by way of an aggregated score indicator that may be computed based on the score indicator or the weighted score indicator.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a processing apparatus for determining a measure of supply-demand balance for transport-related services.

FIG. 2B shows a schematic block diagram illustrating a data record.

FIG. 2C shows a schematic block diagram illustrating architecture component of the processing apparatus of FIG. 2A.

FIG. 2D shows a flow chart illustrating a method for determining a measure of supply-demand balance for transport-related services.

FIG. 3 shows results for ride-hailing transportation services in Singapore, according to various embodiments.

FIGS. 4A to 4G shows results for ride-hailing transportation services in Singapore, according to various embodiments.

### DETAILED DESCRIPTION

Various embodiments may provide techniques, including methods, for computing surge performance. The performance may be defined by a score such as Market Clearing Score (MCS). Market Clearing Score may provide a method to measure surge engine performance and it may be extended to online scenarios where surge engine continuously tries to improve on this metric. Having this score and/or other scoring approaches may pave the way for differentiated surge parameters across the city. Examples of such parameters may include limit and/or sensitivity of step change in surge value, weight of different feature in surge model, etc.

Market Clearing Score, or MCS, provides a metric that measures the performance of the surge engine. The method of computing the MCS involves the calculation of a metric called the sellout rate. Sellout rate calculates the number of service providers (e.g., drivers), for example, for ride-hailing services, that are present in a time duration or interval (e.g., one minute) and the percentage of the available drivers that ends up being utilised by the end of the time duration. For example, the sellout rate may refer to the ratio of number of drivers who were utilised at the end of a specified time frame to the number drivers who were available to take up jobs at any point within the specified time frame. It is preferable to increase the sellout rate as high as possible.

In the techniques disclosed herein, the Market Clearing Score combines the sellout rate (corresponding to service providers, e.g., drivers) and the allocation rate (corresponding to the service users, e.g., passengers) at a geographical area-time period dimension. The geographical area may involve a geohash, e.g., geohash6. Geohash6 defines a cell of a size of about 1.2 km×0.6 km.

Weight factors may be assigned to both metrics, i.e., the allocation rate and the sellout rate. The default value for each weight may be 0.5, which means that equal weightage for customer experience (corresponding to the allocation rate) and the ability to sell out the supply (corresponding to the utilisation rate), may be factored in. A higher weight factor may be assigned to the metric that may be considered more crucial, depending on applications and/or current conditions. For example, the weight may be adjusted to be higher for the allocation rate if customer experience is more important for a particular city.

As compared to known AB tests, the score indicator (or Market Clearing Score) disclosed herein may address the problems associated with such AB-tests. Without the Market Clearing Score, for AB tests, comparisons have to be made on two different metrics—allocation rate and utilisation rate. There could be times where the metrics move in opposite directions, which creates additional complexity in defining whether there is an overall improvement or not by comparing the magnitude of the changes of the two metrics, and whether the magnitude of change of either metric exceeds acceptable ranges. What the scores (e.g., Market Clearing Score) of various embodiments enable is having a single metric that is a composite score of the demand and supply side impact, which may allow for a straightforward rule of “an improvement in the metric is indicative of an overall improvement in the surge engine system” for concluding AB test outcomes. Therefore, Market Clearing Score may allow assessment to be made based on a single metric (i.e., in terms of a score), whilst also allowing for deep-dives into the contributing factors of an increase or decrease in the metric.

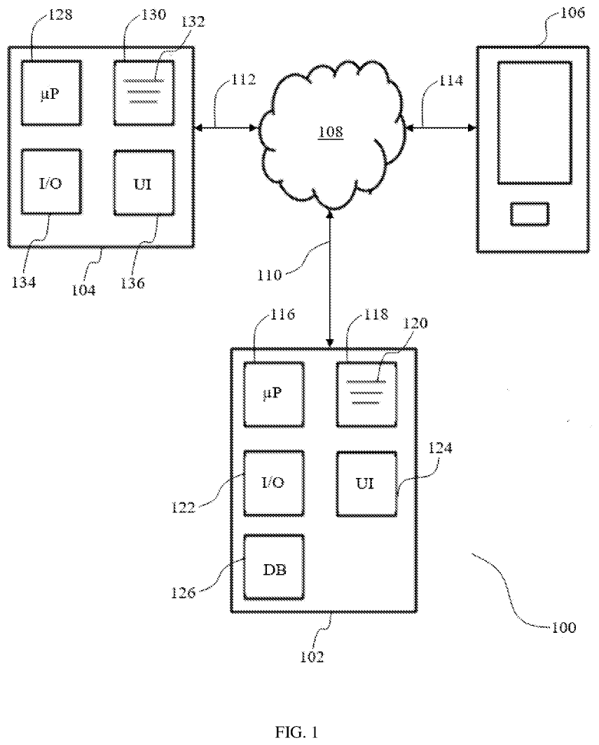

Referring first to FIG. 1, a communications system 100 is illustrated, which may be applicable in various embodiments. The communications system 100 may be for determining a measure of supply-demand balance for transport-related services.

The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (uP) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module (which may be or include a transmitter module and/or a receiver module) 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The communications server apparatus 102 may be for determining a measure of supply-demand balance for transport-related services.

The user communications device 104 may include a number of individual components including, but not limited to, one or more microprocessors (μP) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module (which may be or include a transmitter module and/or a receiver module) 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a desktop or laptop computer, the user interface may have, for example, one or more computing peripheral devices such as display monitors, computer keyboards and the like.

The user communications device 106 may be, for example, a smart phone or tablet device with the same or a similar hardware architecture to that of the user communications device 104.

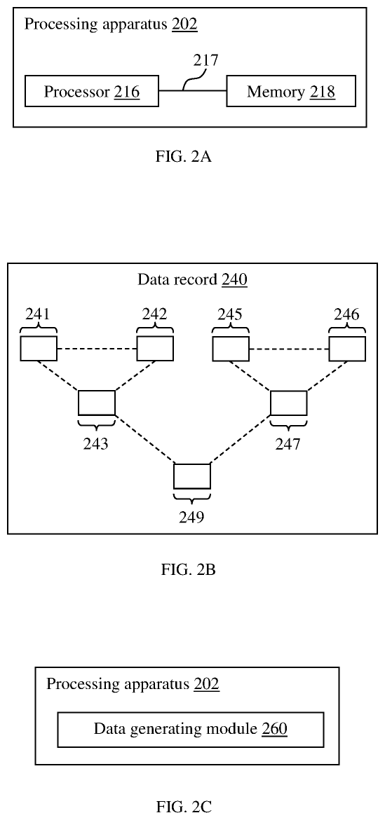

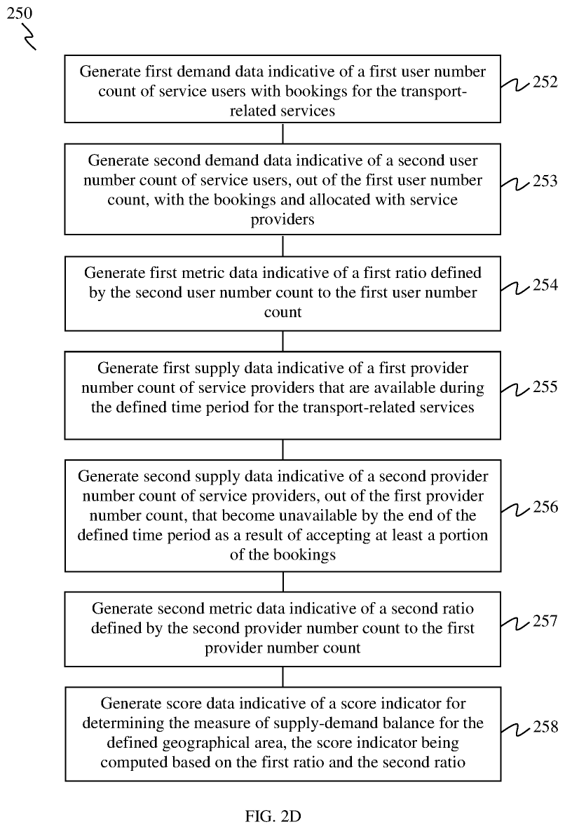

FIG. 2A shows a schematic block diagram illustrating a processing apparatus 202 for determining a measure of supply-demand balance for transport-related services, while FIG. 2B shows a schematic block diagram illustrating a non-limiting example of a data record 240.

The processing apparatus 202 includes a processor 216 and a memory 218, where the processing apparatus 202 is configured, under control of the processor 216 to execute instructions in the memory 218 to, generate, based on a demand for the transport-related services at a defined geographical area by service users over a defined time period and a supply of service providers for the transport-related services at the defined geographical area over the defined time period, in one or more data records 240, first demand data 241 indicative of a first user number count of service users with bookings for the transport-related services, second demand data 242 indicative of a second user number count of service users, out of the first user number count, with the bookings and allocated with service providers, first metric data 243 indicative of a first ratio defined by the second user number count to the first user number count, first supply data 245 indicative of a first provider number count of service providers that are available during the defined time period for the transport-related services, second supply data 246 indicative of a second provider number count of service providers, out of the first provider number count, that become unavailable by the end of the defined time period as a result of accepting at least a portion of the bookings, second metric data 247 indicative of a second ratio defined by the second provider number count to the first provider number count, and score data 249 indicative of a score indicator for determining the measure of supply-demand balance for the defined geographical area, the score indicator being computed based on the first ratio and the second ratio. The processor 216 and the memory 218 may be coupled to each other (as represented by the line 217), e.g., physically coupled and/or electrically coupled.

In other words, there may be provided a processing apparatus 202 for determining a measure of supply-demand balance for transport-related services. The processing apparatus 202 may generate a plurality of data in one or more data records 240 based on a demand for the transport-related services at (or originating from or corresponding to) a defined geographical area by service users (or consumers or recipients or passengers) over (or during) a defined time period, and also based on a supply of service providers (or drivers or vehicles (in the case of autonomous vehicles)) for the transport-related services at the defined geographical area over (or during) the defined time period. The demand and supply may, therefore, be defined for a particular geographical area-time bracket or dimension. As non-limiting examples, the defined time period or interval may be 1 minute, 2 minutes, 5 minutes, 10 minutes or any suitable time period. The defined time period may be within a defined time block, e.g., a 1-hour time block, a 2-hour time block, a 4-hour time block or any suitable time block, for example, a time block of 8:00 am to 10:00 pm, 8:00 am to 12:00 pm, 12:00 pm to 14:00 pm, or 20:00 pm to 21:00 pm, etc.

The service users and/or the service providers may be located at the defined geographical area.

The defined geographical area may be defined in the shape of a square, a rectangle, a hexagon or any other suitable shapes. The defined geographical area may include one or more geohashes. The defined geographical area may cover a (demand) geohash and its neighbouring/adjacent geohashes. A geohash may be defined in the shape of a square, a rectangle, a hexagon or any other suitable shapes. As a non-limiting example, the geohash may include geohash6 which may define a cell of a size of about 1.2 km×0.6 km.

The data that may be generated by the processing apparatus 202 may include first demand data 241 indicative of a first user number count of service users (for or over the defined time period) with bookings for the transport-related services (at the defined geographical area). In other words, the first user number count may be a number count of service users that attempted bookings or that made bookings for the transport-related services (at the defined geographical area). The processing apparatus 202 may further generate second demand data 242 indicative of a second user number count of service users, out of the first user number count (i.e., those who attempted bookings), having (or who made) the bookings for the transport-related services and allocated (or paired or matched) with service providers. The processing apparatus 202 may further generate first metric data 243 indicative of a first ratio (e.g., allocation rate) defined by the second user number count to the first user number count. The first metric data may correspond to a demand metric. The first ratio or allocation rate may be determined based on the number of service users and the number or percentage of the service users who have made bookings and that have been allocated service providers for the transport-related services, corresponding to the defined geographical area and the defined time period.

It should be appreciated that the first user number count includes service users with the bookings and allocated with the service providers (i.e., second user number count) and service users with the bookings but not allocated with the service providers by the end of the defined time period.

The data that may be generated by the processing apparatus 202 may further include first supply data 245 indicative of a first provider number count of service providers that are available (or idle) during the defined time period for the transport-related services (at the defined geographical area). The first provider number count may include service providers who are available for the transport-related services at any point in time during the defined time period, and who do not go offline by or before the end of the time period, i.e., at the end of the time period, they are either still available or become unavailable due to taking on a job or booking. This may mean that the first provider number count may include service providers who are available at or from the start of the defined time period, as well as service providers who become available at any point in time during the defined time period. The available service providers are those that are able to accept bookings, or at least a portion of the bookings made by the service users, meaning that these are service providers that are unoccupied and freely available to provide the transport-related services. Service providers who go offline before the end of the time period refer to service providers that have removed their availability or become unavailable for the transport-related services during the time period for reasons other than taking on a job or booking.

The processing apparatus 202 may further generate second supply data 246 indicative of a second provider number count of service providers, out of the first provider number count (i.e., available service providers), that become unavailable by the end of the defined time period as a result of accepting at least a portion of the bookings made (i.e., meaning service providers that are occupied and would not be available until they have completed the transport-related services corresponding to the bookings). The processing apparatus 202 may further generate second metric data 247 indicative of a second ratio (or sellout rate) defined by the second provider number count to the first provider number count. The second metric data may correspond to a supply metric. The second ratio or sellout rate may be determined based on the number of service providers that are present or available (at any point) during the defined time period (and who do not go offline before the end of the time period) and the number or percentage of the available service providers that end up being utilised by the end of the defined time period. It is preferable to have the second ratio or sellout rate as high as possible.

The processing apparatus 202 may further generate score data 249 indicative of a score indicator (or Market Clearing Score; MCS) for determining the measure of supply-demand balance for the defined geographical area, the score indicator being computed based on the first ratio and the second ratio. The score indicator may also be used to measure surge engine performance for surge pricing, for example, to better manage over-surging and under-surging to meet supply-demand balance. In various embodiments, the score indicator may be computed as a sum of the first ratio and the second ratio. As described, the score indicator takes into account both the demand side and the supply side.

The score indicator may combine the first ratio (or allocation rate) and the second ratio (or sellout rate) for a defined geographical area-defined time period dimension (e.g., a geohash-time dimension).

In the context of various embodiments, the one or more data records 240 may include one or more demand data fields, one or more supply data fields, one or more metric data fields, and one or more score data fields. The processing apparatus 202 may generate, for or in the one or more demand data fields, the first demand data 241 and the second demand data 242. The processing apparatus 202 may generate, for or in the one or more supply data fields, the first supply data 245 and the second supply data 246. The processing apparatus 202 may generate, for or in the one or more metric data fields, the first metric data 243 and the second metric data 247. The processing apparatus 202 may generate, for or in the one or more score data fields, the score data 249.

In the context of various embodiments, the one or more data records 240 may be associated with or accessible by the processing apparatus 202. The one or more data records 240 may be generated by the processing apparatus 202. The one or more data records 240 may be modified or updated by the processing apparatus 202. The one or more data records 240 may be stored at the processing apparatus 202, e.g., in the memory 218.

In various embodiments, the defined time period may include or may be a time period during which service users made requests (or enquiries) for fares (e.g., checking for fares) for the transport-related services. The transport-related services may originate from the defined geographical area.

The processing apparatus 202 may further apply a first weight to the first ratio to produce a weighted first ratio, and generate, in the one or more data records 240, first weighted ratio data indicative of the weighted first ratio. This may mean that the first ratio may be scaled or modified by the first weight, or in other words, multiplying the first ratio with the first weight. The processing apparatus 202 may further apply a second weight to the second ratio to produce a weighted second ratio, and generate, in the one or more data records 240, second weighted ratio data indicative of the weighted second ratio. This may mean that the second ratio may be scaled or modified by the second weight, or in other words, multiplying the second ratio with the second weight. For generating the score data 249, the processing apparatus 202 may generate, in the one or more data records 240, the score data 249 indicative of the score indicator being computed based on the weighted first ratio and the weighted second ratio. The score indicator may be computed as a sum of the weighted first ratio and the weighted second ratio

As a non-limiting example, the processing apparatus 202 may generate first weightage data indicative of the first weight and apply the first weight to the first ratio, and may further generate second weightage data indicative of the second weight and apply the second weight to the second ratio.

A sum of the first weight and the second weight may be equal to one. Each of the first weight and the second weight may be assigned a value of 0.5 (i.e., equal weights). The first weight may be defined as λ, while the second weight may be defined as (1−λ).

In various embodiments, the first weight and the second weight may be varied. The first weight and the second weight may be varied, depending on the supply and demand. The first weight and the second weight may be varied, depending on which one of the metrics, i.e., the first ratio or the second ratio, is to be given more weight or importance. The first weight and the second weight may be varied in real-time.

In various embodiments, the score indicator may be determined by the formula: score indicator=(weighted first ratio)+(weighted second ratio). In greater detail, the score indicator may be computed as [(first weight)×(first ratio)]+[(second weight)×(second ratio)].

The processing apparatus 202 may further apply a third weight (or bracket weight) to the score indicator to produce a weighted score indicator (or weighted Market Clearing Score; weighted MCS). This may mean that the score indicator may be scaled or modified by the third weight, or in other words, multiplying the score indicator with the third weight. The processing apparatus may further generate, in the one or more data records 240, weighted score data indicative of the weighted score indicator (for determining the measure of supply-demand balance). The third weight may be used to reflect the different levels of demand and supply across space and/or time.

As a non-limiting example, the processing apparatus 202 may generate third weightage data indicative of the third weight and apply the third weight to the score indicator.

The processing apparatus 202 may further generate, in the one or more data records 240, data indicative of a third user number count of non-booking service users, the non-booking service users being service users who made requests for fares for the transport-related services during the defined time period and without making bookings for the transport-related services by the end of the defined time period, data indicative of a third provider number count of service providers, out of the first provider number count, that are not utilised (or not allocated) by the end of the defined time period (even though they are still available), and data indicative of the third weight, the third weight being computed based on the first user number count and a minimum count of the third user number count or the third provider number count. This may mean that, whichever of the third user number count of non-booking service users and the third provider number count of non-utilised service providers is determined to be lower, the determined lower count is the minimum count or number. The third weight may be computed as a sum of the first user number count and the minimum count. In greater detail, the minimum count may be defined as Min{third user number count, third provider number count}.

The processing apparatus 202 may further apply a fourth weight to the first user number count to produce a weighted first user number count, and generate, in the one or more data records 240, first weighted count data indicative of the weighted first user number count. This may mean that the first user number count may be scaled or modified by the fourth weight, or in other words, multiplying the first user number count with the fourth weight. The processing apparatus 202 may further apply a fifth weight to the minimum count to produce a weighted minimum count, and generate, in the one or more data records 240, second weighted count data indicative of the weighted minimum count. This may mean that the minimum count may be scaled or modified by the fifth weight, or in other words, multiplying the minimum count with the fifth weight. For generating the data indicative of the third weight, the processing apparatus 202 may generate, in the one or more data records 240, the data indicative of the third weight being computed based on the weighted first user number count and the weighted minimum count. The third weight may be computed as a sum of the weighted first user number count and the weighted minimum count.

As a non-limiting example, the processing apparatus 202 may generate fourth weightage data indicative of the fourth weight and apply the fourth weight to the first user number count, and may further generate fifth weightage data indicative of the fifth weight and apply the fifth weight to the minimum count.

A sum of the fourth weight and the fifth weight may be equal to one. Each of the fourth weight and the fifth weight may be assigned a value of 0.5 (i.e., equal weights). The fourth weight may be defined as β, while the fifth weight may be defined as (1−β).

In various embodiments, the fourth weight and the fifth weight may be varied. The fourth weight and the fifth weight may be varied, depending on consideration of identifying over-surging versus under-surging. The fourth weight and the fifth weight may be varied, depending on which one of the metrics, i.e., the weighted first user number count or the weighted minimum count, should be given more weight or importance. The fourth weight and the fifth weight may be varied in real-time.

In various embodiments, the third weight may be determined by the formula: third weight=(weighted first user number count)+(weighted minimum count). For example, with the above formula, more weight may be assigned to space-time brackets where there may be potential opportunities for surge engine to improve the allocation or sellout rate metrics. In greater detail, the third weight may be computed as [(fourth weight)×(first user number count)]+[(fifth weight)×(minimum count)].

The processing apparatus 202 may further generate, based on demands for transport-related services at (or corresponding to) a plurality of defined geographical areas by service users over the defined time period and a supply of service providers for the transport-related services at the plurality of defined geographical areas over the defined time period, in the one or more data records 240 and, for each defined geographical area, the weighted score data indicative of the weighted score indicator, and the data indicative of the third weight. The processing apparatus 202 may further generate, in the one or more data records 240, aggregated score data indicative of an aggregated score indicator (or aggregated Market Clearing Score; aggregated MCS) for determining the measure of supply-demand balance for (or across) the plurality of defined geographical areas, the aggregated score indicator being computed based on the weighted score indicators and the third weights corresponding to the plurality of defined geographical areas. The plurality of defined geographical areas may define or make up a (larger) geographical region, for example, a town, a city, etc.

For each defined geographical area, the weighted score indicator may be computed by applying the third weight to the score indicator, which in turn may be computed based on the weighted first ratio and the weighted second ratio. The third weight may be computed based on the weighted first user number count and the weighted minimum count, where the weighted first user number count may in turn be computed by applying the fourth weight to the first user number count, and the weighted minimum count may in turn be computed by applying the fifth weight to the minimum count.

Calculating the aggregated score indicator may allow for comparison of the surge engine comparison across different sets of plurality of defined geographical areas and/or across different time durations or time blocks.

In various embodiments, the aggregated score indicator may be determined by the formula: aggregated score indicator=Σ(weighted score indicator)/Σ(third weight), where Σ means summation, and (weighted score indicator) and (third weight) correspond to the each defined geographical area. In other words, the aggregated score indicator may be computed as a ratio of the sum of the weighted score indicator corresponding to each of the plurality of defined geographical areas, to the sum of the third weights for the plurality of defined geographical areas.

FIG. 2C shows a schematic block diagram illustrating architecture component of the processing apparatus 202. That is, the processing apparatus 202 may further include a data generating module 260 to generate the respective data 241, 242, 243, 245, 246, 247, 249 (see FIG. 2B).

In the context of various embodiments, the processing apparatus 202, may be or may include a communications server apparatus, and may be, for example, as described in the context of the server device 102 (FIG. 1). The processor 216 may be as described in the context of the processor 116 (FIG. 1) and/or the memory 218 may be as described in the context of the memory 118 (FIG. 1).

In the context of various embodiments, the processing apparatus 202 may be a single apparatus or server, or have the functionality performed by the processing apparatus 202 distributed across multiple apparatus or server components.

FIG. 2D shows a flow chart 250 illustrating a method for determining a measure of supply-demand balance for transport-related services. The method includes generating, based on a demand for the transport-related services at a defined geographical area by service users over a defined time period and a supply of service providers for the transport-related services at the defined geographical area over the defined time period, data in one or more data records.

At 252, first demand data is generated. The first demand data is indicative of a first user number count of service users with bookings for the transport-related services.

At 253, second demand data is generated. The second demand data is indicative of a second user number count of service users, out of the first user number count, with the bookings (for the transport-related services) and allocated with service providers.

At 254, first metric data is generated. The first metric data is indicative of a first ratio defined by the second user number count to the first user number count.

At 255, first supply data is generated. The first supply data is indicative of a first provider number count of service providers that are available during the defined time period for the transport-related services.

At 256, second supply data is generated. The second supply data is indicative of a second provider number count of service providers, out of the first provider number count, that become unavailable by the end of the defined time period as a result of accepting at least a portion of the bookings.

At 257, second metric data is generated. The second metric data is indicative of a second ratio defined by the second provider number count to the first provider number count.

At 258, score data is generated. The score data is indicative of a score indicator for determining the measure of supply-demand balance for the defined geographical area, the score indicator being computed based on the first ratio and the second ratio.

The defined time period may include or may be a time period during which service users made requests for fares for the transport-related services.

The method may further include applying a first weight to the first ratio to produce a weighted first ratio, and generating, in the one or more data records, first weighted ratio data indicative of the weighted first ratio, and applying a second weight to the second ratio to produce a weighted second ratio, and generating, in the one or more data records, second weighted ratio data indicative of the weighted second ratio. At 258, the method may include generating, in the one or more data records, the score data indicative of the score indicator being computed based on the weighted first ratio and the weighted second ratio.

The score indicator may be determined by the formula: score indicator=(weighted first ratio)+(weighted second ratio).

The method may further include applying a third weight to the score indicator to produce a weighted score indicator, and generating, in the one or more data records, weighted score data indicative of the weighted score indicator.

The method may further include generating, in the one or more data records, data indicative of a third user number count of non-booking service users, the non-booking service users being service users who made requests for fares for the transport-related services during the defined time period and without making bookings for the transport-related services by the end of the defined time period, data indicative of a third provider number count of service providers, out of the first provider number count, that are not utilised by the end of the defined time period, and data indicative of the third weight, the third weight being computed based on the first user number count and a minimum count of the third user number count or the third provider number count.

The method may include applying a fourth weight to the first user number count to produce a weighted first user number count, and generating, in the one or more data records, first weighted count data indicative of the weighted first user number count, and applying a fifth weight to the minimum count to produce a weighted minimum count, and generating, in the one or more data records, second weighted count data indicative of the weighted minimum count. The method may further include generating, in the one or more data records, the data indicative of the third weight being computed based on the weighted first user number count and the weighted minimum count.

The third weight may be determined by the formula: third weight=(weighted first user number count)+(weighted minimum count).

The method may further include generating, based on demands for transport-related services at (or corresponding to) a plurality of defined geographical areas by service users over the defined time period and a supply of service providers for the transport-related services at the plurality of defined geographical areas over the defined time period, in the one or more data records and, for each defined geographical area, the weighted score data indicative of the weighted score indicator, and the data indicative of the third weight, and, generating, in the one or more data records, aggregated score data indicative of an aggregated score indicator for determining the measure of supply-demand balance for the plurality of defined geographical areas, the aggregated score indicator being computed based on the weighted score indicators and the third weight corresponding to the plurality of defined geographical areas.

The aggregated score indicator may be determined by the formula: aggregated score indicator=Σ(weighted score indicator)/Σ(third weight), where Σ means summation, and (weighted score indicator) and (third weight) correspond to the each defined geographical area.

The method as described in the context of the flow chart 250 may be performed in a processing apparatus (e.g., 202; FIG. 2A) for determining a measure of supply-demand balance for transport-related services, under control of a processor of the apparatus. The method may further include, executing under control of the processor, instructions stored in a memory of the processing apparatus, operating a data generating module (e.g., 260, FIG. 2C) to generate the first demand data, second demand data, first metric data, first supply data, second supply data, second metric data and score data.

It should be appreciated that description in the context of the processing apparatus 202 may correspondingly be applicable in relation to the method as described in the context of the flow chart 250, and vice versa.

In the context of various embodiments, the transport-related services may include or may be transportation services, delivery services, logistics, etc. Transportation services may include ride-hailing or ride-sharing transportation services. This may include, for example, car-hailing, and (motor)bike-hailing services.

There may also be provided a computer program product having instructions for implementing the method for determining a measure of supply-demand balance for transport-related services as described herein.

There may also be provided a computer program having instructions for implementing the method for determining a measure of supply-demand balance for transport-related services as described herein.

There may further be provided a non-transitory storage medium storing instructions, which, when executed by a processor, cause the processor to perform the method for determining a measure of supply-demand balance for transport-related services as described herein.

Various embodiments or techniques will now be further described in detail, based on transportation services involving drivers and passengers as non-limiting examples. As further non-limiting examples, the geographical area is defined as geohash6, and the time period or interval is defined to be 1 minute.

The Market Clearing Score (MCS) may be made up of the components as set out below.

Sellout Rate for a Demand Geohash-Minute
(i) The number of drivers that is available is counted or determined as supply to the demand in a particular geohash.
   (a) Drivers that are available as supply is assumed to be from the demand geohash itself as well as the neighbouring geohashes (this includes the adjacent geohashes as well as the diagonal geohashes).
   (b) The available drivers (STATE:IDLE) are aggregated for a minute to compute the number of such drivers.
   (c) At the end of the minute, the number of drivers that have accepted a job as they changed states from IDLE to UNAVAILABLE is counted. The number of drivers who accepted jobs may be the same as the number of passengers that are allocated drivers. There may be instances where the number of drivers may be more than the number of passengers if there are drivers assigned to jobs outside of the geohash.
(ii) To compute the sellout rate, the number of drivers that have become UNAVAILABLE by the end of the minute is divided against the number of drivers that were available during the minute, provided the drivers remained online (i.e., either IDLE or on a job) at the end of the minute. It should be appreciated that a driver that started being available at any point in time during the minute, e.g., at the half-way mark of the minute, is still counted as an available driver. Accordingly, the sellout rate refers to the ratio of the number of drivers that were in the IDLE (or AVAILABLE) state during the minute and that have changed to the UNAVAILABLE state (as a result of taking on jobs) by the end of the minute to the number of drivers that include those that were in the IDLE state at the start of the minute and those that entered the IDLE state at any point in the minute, where the drivers were either IDLE or UNAVAILABLE at the end of the minute.

Pax Net Allocation Rate for a Geohash-Minute
(i) The number of passengers who made a fare check for a trip originating from a pickup Point-of-Interest (POI) in the geohash6 during the 1-minute interval is counted.
   (a) Amongst the passengers who made a fare check, the number of passengers who attempted a booking (i.e., those that made bookings) is determined. Passengers who attempted bookings include passengers that, while having booked transport-related services (e.g., passengers who have clicked or pressed the “Book” button or the like), have not been allocated drivers. As a non-limiting example, the overall flow may be: Passengers who made fare checks>=Passengers who made bookings>=Passengers who were allocated with drivers.
   (b) Of those passengers who booked, the number of passengers who got allocated to a driver is determined. In a non-limiting example, this may refer to the number of passengers who were allocated drivers who did not cancel within, for example, 30 seconds, of allocation time. Allocation is counted only if drivers do not cancel shortly after allocation so as to cater for true allocation to drivers who may have the auto-accept feature turned on. As these drivers automatically accept all jobs sent to them, they are only able to reject a job via cancelling, instead of choosing to not take up a job sent to them. As a non-limiting example, jobs may be allocated to different drivers sequentially. A driver may only receive a job if a previous driver has cancelled the same job. As another non-limiting example, drivers may opt to manually decide whether to accept jobs sent to them, where these drivers can reject a job by not accepting the job. As a further non-limiting example, there may be a mixture of drivers who automatically accept all jobs sent to them, and drivers who have opted to manually decide whether to accept jobs sent to them.
   (c) All of the above counts are attributed back to the time of the fare check. For example, the process of allocation may take longer than 1 minute, so when allocation event happens, the allocation rate may be calculated by counting the allocation event based on the start of the allocation process, which may be before the current 1 minute.
(ii) The pax allocation rate is the ratio of the number of passengers who booked and were allocated drivers to the number of passengers who made a booking attempt (i.e., inclusive of passengers who were allocated drivers and also passengers still awaiting allocation (or not allocated with drivers yet)).

It should be appreciated that the allocation rate and the sellout rate may be computed over the same duration of 1 minute (i.e., 1-minute interval). Further, it should be appreciated that the 1-minute interval may correspond to the same exact time. As a non-limiting example, the allocation rate and the sellout rate may be determined over a 1-minute interval for the time period 8:00 pm to 8:01 pm.

The allocation rate and the sellout rate may be combined to determine the Market Clearing Score.

As a non-limiting example, the Market Clearing Score (MCS) may be a weighted average of the allocation rate and the sellout rate, as determined by Equation (1) below:

Score=[λ×Allocation rate]+[(1−λ)×Sellout rate] Equation (1),

where λ is a weight (factor).

While there may be other approaches, Equation (1) provides a definition that is simple and yet one that may constraint the range of score to between 0 and 1.

A higher Score may indicate a better surge performance. As a non-limiting example, a perfect Score may be 1.

The weight, λ, may be given a value in the range of between 0.1 to 0.9. As a non-limiting example, the default value for λ may be set as 0.5.

The weight, λ, may be decided by one or more of (i) feedback from local market based on different market dynamic resulting from different λ values, and (ii) correlating MCS with GMV (Gross Merchandise Volume—which is the total fare paid by the passengers) to determine which one is more efficient on high level (referring to the local market that is within consideration, which may be a service type or a city). Nevertheless, it should be appreciated that the correlation may be MCS versus any other business metric that the service provider is optimising for, e.g., revenue, profit margin, etc.

As there may be different levels of demand and supply across space and time, it is preferable to not provide equal weighting to poor allocation in a space-time bucket (or bracket or dimension) with few passengers and for another space-time bucket (or bracket or dimension) with the same level of poor allocation but with more passengers. Similarly, a low sellout rate may be more undesired when there are more available drivers versus when there are few idle drivers around.

As such, a bracket weight for the importance of a geohash6-1 minute bucket in defining the surge engine performance may be computed for determining a weighted Market Clearing Score (weighted MCS). The same 1-minute interval applies, for the same time period as that for determining the allocation rate and the sellout rate.

The weighted Market Clearing Score (weighted MCS) may be determined by Equation (2) below:

weighted MCS=Weight×Score Equation (2).

The bracket weight, “Weight”, may include the two following components.
(i) Number of passengers who booked, “Pax booked”.

A high number of passengers booking indicate a potential for under-surging, as passengers are more inclined to book when prices are lower than what they should have been.
(ii) Minimum of the number of passenger who bounced (i.e., passengers who made fare checks but did not proceed to make bookings), “Pax Bounced”, and drivers who were available and remained unutilised at the end of the minute, “Unutilised Dax”.

This is the maximum number of additional matches of passengers and drivers that could have been made if surge was lower and more passengers made a booking. It is an indicator of the degree of over-surging.

A weighted average (via use of weight factor β) of the above two parameters (numbers) may be used to calculate the bracket weight (“Weight”) to be assigned to a geohash-1 minute interval according to Equation (3) below:

Weight=(β×Pax Booked)+[(1−β)×Min{Pax Bounced, Unutilised Dax}] Equation (3).

As a non-limiting example, the default value for β may be 0.5, for equal consideration of over-surging and under-surging, but the choice for β may depend on the relative importance of identifying over-surging versus under-surging.

The weight factors, β and (1−β), may also be informed by an understanding of the overall demand-supply balance in the market. A large number of passengers bouncing when there are many unutilised drivers may signify a larger loss of opportunity in an oversupplied market than in an undersupplied market, so a larger weight factor may be set for Min{Pax Bounced, Unutilised Dax}. This may mean that β may be set lower than 0.5.

Using Equation (3), a higher bracket weight may be assigned to space-time buckets where there may be potential opportunities for surge engine to improve the allocation or sellout rate metrics. This may help to mitigate the impact of inherent changes in demand or supply on the performance metric of the surge engine.

In various embodiments, the value of the weight factor β may be set to be the same as the value of the weight λ.

The techniques disclosed herein may further enable aggregation of Market Clearing Score to a city, which may provide a single number to provide a measure for the city. There is the ability to aggregate the Market Clearing Score to any level of granularity across space and/or time, meaning that the aggregated Market Clearing Score (aggregated MCS) may be calculated for any area size and/or any time frame. This may allow for easy comparison across space and time. Computation of the aggregated MCS may be provided by Equation (4) below:

$$\\ \begin{matrix}Aggregated MCS = \frac{\sum ( Weight \times Score )}{\sum Weight} , & Equation ( 4 )\end{matrix}$$

where “Weight” may be determined using Equation (3) and “Score” may be determined using Equation (1). Effectively, “(Weight×Score)” refers to the weighted MCS according to Equation (2).

Each of the summations, ΣWeight and Σ(Weight×Score), may be across at least one of two or more geographical areas (or geohashes), or two or more time blocks (e.g., a time block may be from 8:00 am to 10:00 am). As a non-limiting example, assuming that there are n geographical areas and m time blocks, each of the summations may be for any of 1 to n geographical areas and any of 1 to m time blocks.

As a non-limiting example, the aggregated MCS may be computed over all geohashes of a city.

The aggregated MCS may be for AB test to determine whether surge performance has improved. In generalised terms, an AB test here refers to a randomised experiment to compare two different surge engines, which may be two different surge engine models, or two different sets of surge engine parameters for the same model. The comparison is to determine which model/set of parameters may be better, and the aggregated MCS may be the metric of comparison. A higher aggregated MCS may indicate a better surge performance. As a non-limiting example, a perfect value for aggregated MCS may be 1. As a non-limiting comparison example, City A having an aggregated MCS that is of a higher value compared to the aggregated MCS of City B means that City A has a higher efficiency in clearing market excess demand and supply.

In various embodiments, determination for surge performance may be determined from two levels, for example, at a granular or local view (e.g., geohash-1 minute bracket or geohash-5 minute bracket, etc.) by computing Equation (1), and a wider view for determining city performance by computing Equation (4). Localised or granular area and/or time may be analysed, by obtaining the Market Clearing Score according to Equation (1) and then determining what surge could have done to bring improvement at that level. Nevertheless, there may also be a need to monitor overall city performance on a periodic basis, which is the function of the aggregated Market Clearing Score according to Equation (4), and which may require an objective way to aggregate the Market Clearing Score.

By obtaining MCS and aggregated MCS, and which may, for example, be productionised in online systems of a service provider, surge machine learning models may be used to optimise this metric live to improve surge performance. This may lead to optimising or maximising the number of successful matches between demand and supply, i.e., the market may be brought to an equilibrium point where most customers' demand may be fulfilled with least number of drivers idle, thus leading to supply-demand balance.

It should be appreciated that any data generating actions may be performed by a processing apparatus (e.g., 202, FIG. 2A) or a data generating module thereof (e.g., 260, FIG. 2C).

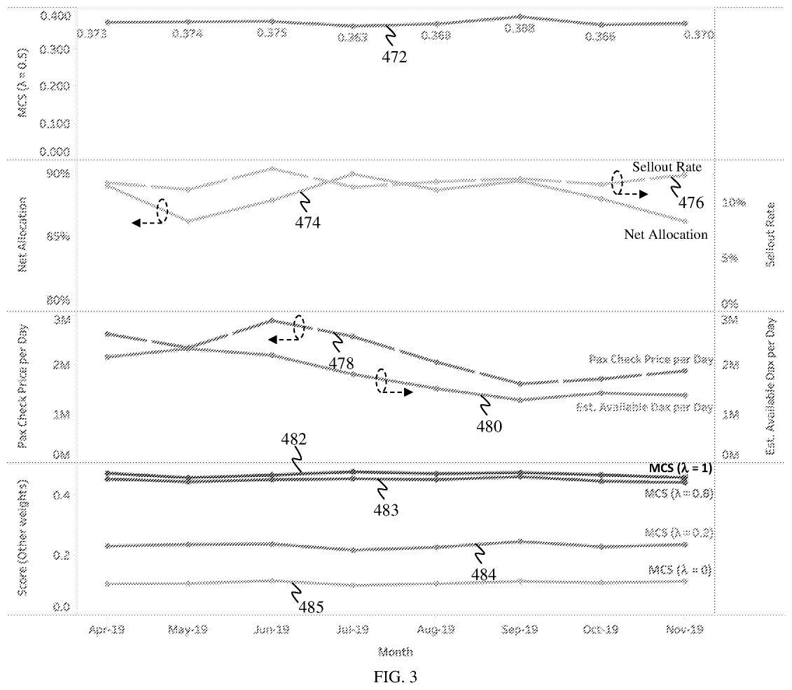

FIG. 3 shows results for ride-hailing transportation services in Singapore, according to various embodiments, during the period from April 2019 to November 2019.

These include data 472 for aggregated Market Clearing Score (aggregated MCS) based on weight, λ=0.5, data 474 for net allocation rate, data 476 for sellout rate, data 478 for number of passengers checking fares per day, data 480 for estimated available drivers per day, data 482, 483, 484, 485 for aggregated Market Clearing Score based on λ=1, 0.8, 0.2, 0, respectively. While not indicated in FIG. 3, for the purposes of computing the aggregated Market Clearing Score, the values for β and λ are the same, e.g., when λA=0.2, β=0.2 too.

As may be observed in FIG. 3, from October 2019 to November 2019, net allocation (see data 474) worsened while the sellout rate (see data 476) improved. Despite the opposite movements of the two metrics, the aggregated Market Clearing Score as a combined metric provides an indication that the surge engine performance in November 2019 was better than in October 2019, as the degree of improvement in the sellout rate exceeded the degree of worsening of net allocation, at the default weight of 0.5 assigned to these metrics (see data 472).

Further, it may be observed that a higher aggregated MCS may be obtained for higher λ value, meaning that the allocation rate may be favoured, and therefore given more weight, compared to the sellout rate.

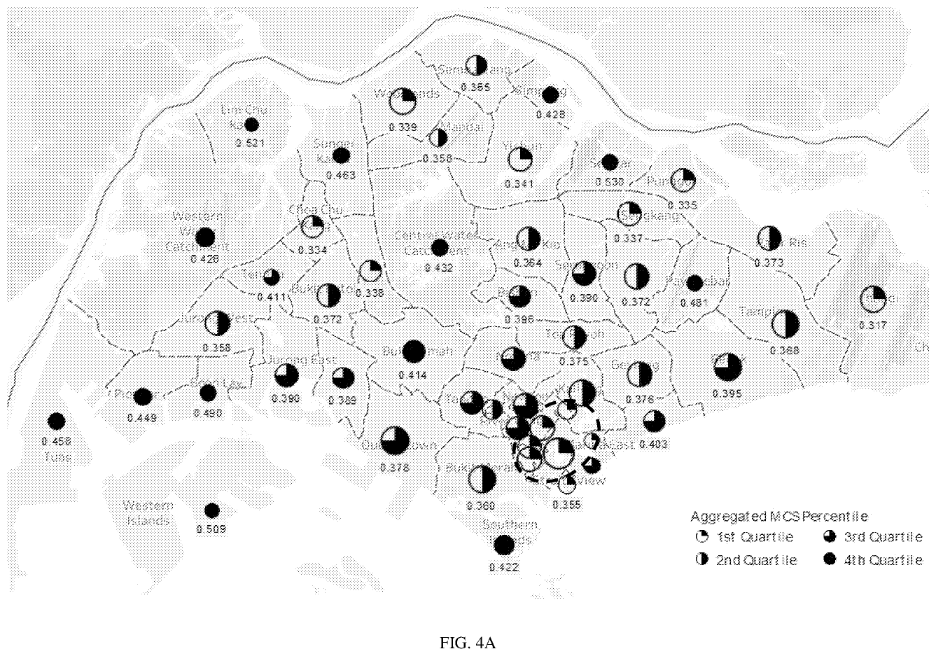

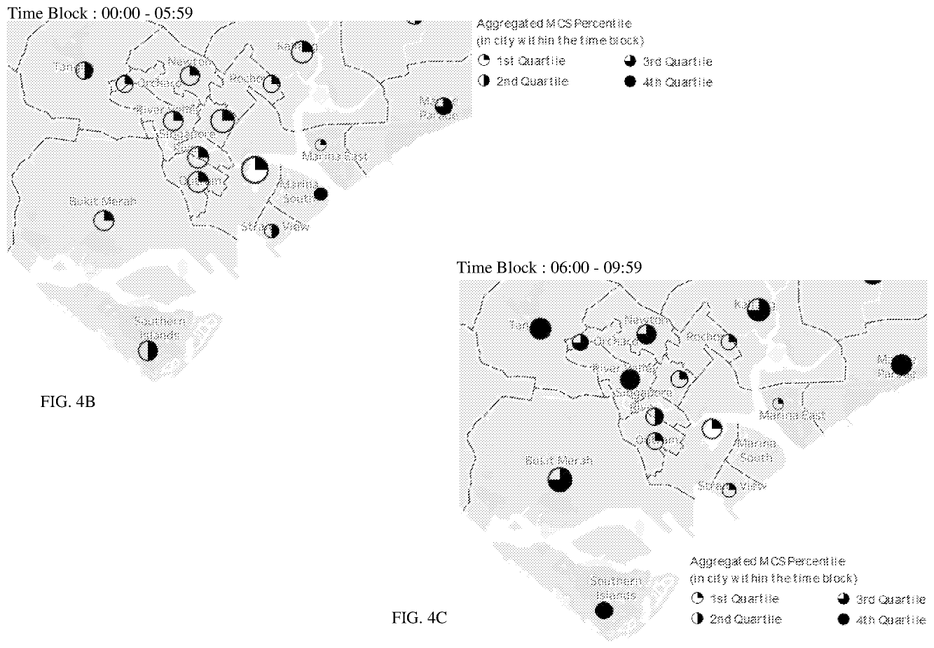

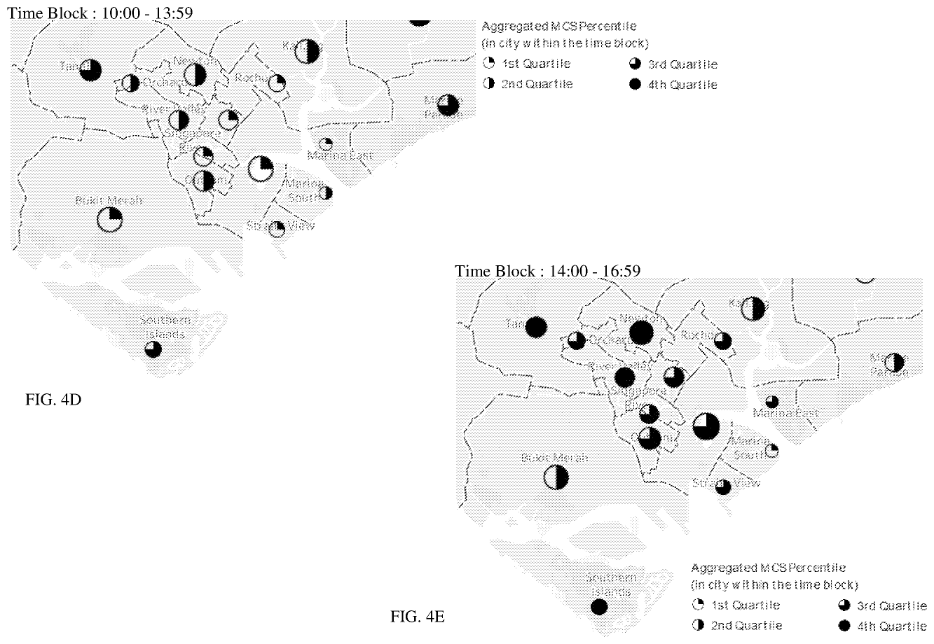

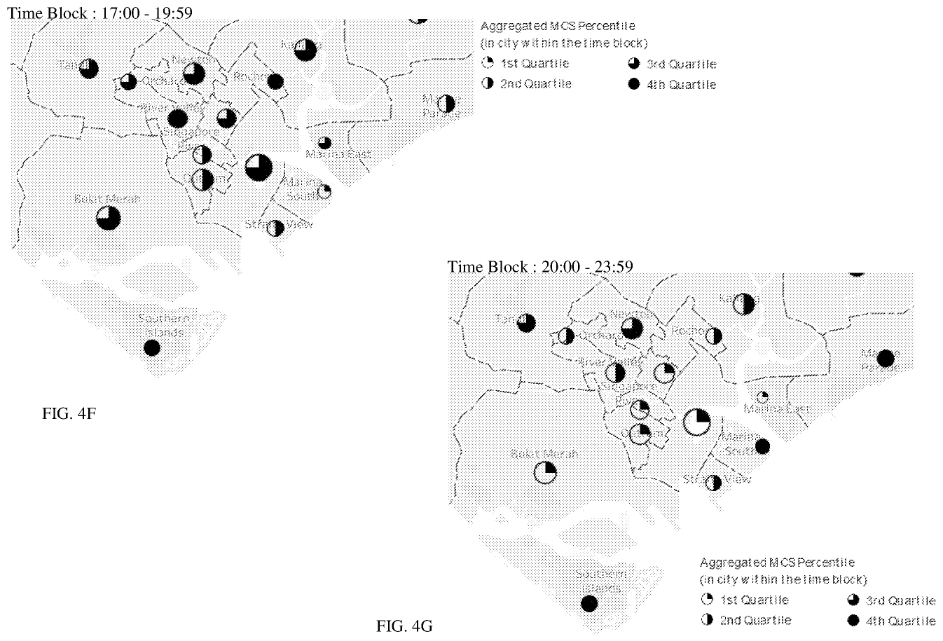

Calculating the aggregated Market Clearing Score for each different geographic area allows for comparison of the surge engine across different areas. FIGS. 4A to 4G shows results for ride-hailing transportation services in Singapore, according to various embodiments, to illustrate spatial comparison of aggregated MCS based on weight, λ, =0.5 (and β=0.5). In FIGS. 4A to 4G, the circles are differently illustrated depending on their respective MCS, according to the legend provided, and also differently sized based on the total number of passengers checking the fares. The aggregated MCS is calculated for each area, and the areas are ranked based on the aggregated MCS. The first quartile (1st Quartile) corresponds to (or represents) areas with aggregated MCS within the lowest 1-25th percentile (i.e., areas with the lowest aggregated MCS scores), the second quartile (2nd Quartile) corresponds to areas with aggregated MCS for the 16-50th percentile, the third quartile (3rd Quartile) corresponds to areas with aggregated MCS for the 51-75th percentile, and the fourth quartile (4th Quartile) corresponds to areas with aggregated MCS amongst the top percentiles (i.e., areas with the highest aggregated MCS scores). FIGS. 4B to 4G show results for areas ranked based on the aggregated MCS for the respective indicated blocks of time.

Referring to FIG. 4A, the overall spatial view shows that there is a cluster of worse-performing areas in the Downtown area (see the circles within the dashed oval). Further, drilling down into time blocks of FIGS. 4B to 4G show that the MCS is particularly bad in this area during the late night, from 8 pm to 6 am.

Identifying space-time buckets (or brackets) of low MCS may allow us to (1) apply different sets of surge engine parameters (the parameters include, but not limited to, limit and/or sensitivity of step change in surge value, weight of different feature in surge model, the degree of spatial smoothing of surge multiplier values, and threshold values of input signals that trigger surge) during these times for these areas for surge-engine optimisation (e.g., minimisation of undersurging and oversurging instances, which may be done via tuning of the surge engine parameters, or addition of new signal and/or parameters into the surge engine in the short-term, and/or (2) identify common characteristics (including, but not limited to, time of day, number of fare checks, average estimated time to arrival for allocated drivers, rate of change of allocation rate) of these areas and times with poor MCS to share and use this knowledge to build one or more additional surge engine features to improve the MCS.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A processing apparatus for determining a measure of supply-demand balance for transport-related services, comprising a processor and a memory, the processing apparatus being configured, under control of the processor to execute instructions in the memory to:
generate, based on a demand for the transport-related services at a defined geographical area by service users over a defined time period and a supply of service providers for the transport-related services at the defined geographical area over the defined time period, in one or more data records,
first demand data indicative of a first user number count of service users with bookings for the transport-related services;
second demand data indicative of a second user number count of service users, out of the first user number count, with the bookings and allocated with service providers;
first metric data indicative of a first ratio defined by the second user number count to the first user number count;
first supply data indicative of a first provider number count of service providers that are available during the defined time period for the transport-related services;
second supply data indicative of a second provider number count of service providers, out of the first provider number count, that become unavailable by the end of the defined time period as a result of accepting at least a portion of the bookings;
second metric data indicative of a second ratio defined by the second provider number count to the first provider number count; and
score data indicative of a score indicator for determining the measure of supply-demand balance for the defined geographical area, the score indicator being computed based on the first ratio and the second ratio.

2. The processing apparatus as claimed in claim 1, wherein the defined time period comprises a time period during which service users made requests for fares for the transport-related services.

3. The processing apparatus as claimed in claim 1 or 2, further configured to:
apply a first weight to the first ratio to produce a weighted first ratio, and generate, in the one or more data records, first weighted ratio data indicative of the weighted first ratio; and
apply a second weight to the second ratio to produce a weighted second ratio, and generate, in the one or more data records, second weighted ratio data indicative of the weighted second ratio;
wherein, for generating the score data, the processing apparatus is configured to generate, in the one or more data records, the score data indicative of the score indicator being computed based on the weighted first ratio and the weighted second ratio.

4. The processing apparatus as claimed in claim 3, wherein the score indicator is determined by the formula:
score indicator=(weighted first ratio)+(weighted second ratio).

5. The processing apparatus as claimed in claim 1, further configured to:
apply a third weight to the score indicator to produce a weighted score indicator; and
generate, in the one or more data records, weighted score data indicative of the weighted score indicator.

6. The processing apparatus as claimed in claim 5, further configured to generate, in the one or more data records:
data indicative of a third user number count of non-booking service users, the non-booking service users being service users who made requests for fares for the transport-related services during the defined time period and without making bookings for the transport-related services by the end of the defined time period;
data indicative of a third provider number count of service providers, out of the first provider number count, that are not utilised by the end of the defined time period; and
data indicative of the third weight, the third weight being computed based on the first user number count and a minimum count of the third user number count or the third provider number count.

7. The processing apparatus as claimed in claim 6, further configured to:
apply a fourth weight to the first user number count to produce a weighted first user number count, and generate, in the one or more data records, first weighted count data indicative of the weighted first user number count; and
apply a fifth weight to the minimum count to produce a weighted minimum count, and generate, in the one or more data records, second weighted count data indicative of the weighted minimum count;
wherein, for generating the data indicative of the third weight, the processing apparatus is configured to generate, in the one or more data records, the data indicative of the third weight being computed based on the weighted first user number count and the weighted minimum count.

8. The processing apparatus as claimed in claim 7, further configured to:
generate, based on demands for transport-related services at a plurality of defined geographical areas by service users over the defined time period and a supply of service providers for the transport-related services at the plurality of defined geographical areas over the defined time period, in the one or more data records and, for each defined geographical area,
the weighted score data indicative of the weighted score indicator; and
the data indicative of the third weight; and
generate, in the one or more data records, aggregated score data indicative of an aggregated score indicator for determining the measure of supply-demand balance for the plurality of defined geographical areas, the aggregated score indicator being computed based on the weighted score indicators and the third weights corresponding to the plurality of defined geographical areas.

9. The processing apparatus as claimed in claim 8, wherein the aggregated score indicator is determined by the formula:
aggregated score indicator=Σ(weighted score indicator)/Σ(third weight),
where Σ means summation, and (weighted score indicator) and (third weight) correspond to the each defined geographical area.

10. A method for determining a measure of supply-demand balance for transport-related services, the method comprising:
generating, based on a demand for the transport-related services at a defined geographical area by service users over a defined time period and a supply of service providers for the transport-related services at the defined geographical area over the defined time period, in one or more data records,
first demand data indicative of a first user number count of service users with bookings for the transport-related services;
second demand data indicative of a second user number count of service users, out of the first user number count, with the bookings and allocated with service providers;
first metric data indicative of a first ratio defined by the second user number count to the first user number count;
first supply data indicative of a first provider number count of service providers that are available during the defined time period for the transport-related services;
second supply data indicative of a second provider number count of service providers, out of the first provider number count, that become unavailable by the end of the defined time period as a result of accepting at least a portion of the bookings;
second metric data indicative of a second ratio defined by the second provider number count to the first provider number count; and
score data indicative of a score indicator for determining the measure of supply-demand balance for the defined geographical area, the score indicator being computed based on the first ratio and the second ratio.

11. The method as claimed in claim 10, wherein the defined time period comprises a time period during which service users made requests for fares for the transport-related services.

12. The method as claimed in claim 10, further comprising:
applying a first weight to the first ratio to produce a weighted first ratio, and generating, in the one or more data records, first weighted ratio data indicative of the weighted first ratio; and
applying a second weight to the second ratio to produce a weighted second ratio, and generating, in the one or more data records, second weighted ratio data indicative of the weighted second ratio;
wherein generating the score data comprises generating, in the one or more data records, the score data indicative of the score indicator being computed based on the weighted first ratio and the weighted second ratio.

13. The method as claimed in claim 12, wherein the score indicator is determined by the formula:
score indicator=(weighted first ratio)+(weighted second ratio).

14. The method as claimed in claim 10, further comprising:
applying a third weight to the score indicator to produce a weighted score indicator; and
generating, in the one or more data records, weighted score data indicative of the weighted score indicator.

15. The method as claimed in claim 14, further comprising generating, in the one or more data records:
data indicative of a third user number count of non-booking service users, the non-booking service users being service users who made requests for fares for the transport-related services during the defined time period and without making bookings for the transport-related services by the end of the defined time period;
data indicative of a third provider number count of service providers, out of the first provider number count, that are not utilised by the end of the defined time period; and
data indicative of the third weight, the third weight being computed based on the first user number count and a minimum count of the third user number count or the third provider number count.

16. The method as claimed in claim 15, further configured to:
applying a fourth weight to the first user number count to produce a weighted first user number count, and generating, in the one or more data records, first weighted count data indicative of the weighted first user number count; and
applying a fifth weight to the minimum count to produce a weighted minimum count, and generating, in the one or more data records, second weighted count data indicative of the weighted minimum count;
wherein generating the data indicative of the third weight comprises generating, in the one or more data records, the data indicative of the third weight being computed based on the weighted first user number count and the weighted minimum count.

17. The method as claimed in claim 16, further comprising:
generating, based on demands for transport-related services at a plurality of defined geographical areas by service users over the defined time period and a supply of service providers for the transport-related services at the plurality of defined geographical areas over the defined time period, in the one or more data records and, for each defined geographical area,
the weighted score data indicative of the weighted score indicator; and
the data indicative of the third weight; and
generating, in the one or more data records, aggregated score data indicative of an aggregated score indicator for determining the measure of supply-demand balance for the plurality of defined geographical areas, the aggregated score indicator being computed based on the weighted score indicators and the third weight corresponding to the plurality of defined geographical areas.

18. The method as claimed in claim 17, wherein the aggregated score indicator is determined by the formula:
aggregated score indicator=Σ(weighted score indicator)/Σ(third weight),
where Σ means summation, and (weighted score indicator) and (third weight) correspond to the each defined geographical area.

19. (canceled)

20. A non-transitory storage medium storing instructions, which when executed by a processor cause the processor to perform the method as claimed in claim 10.
